(19) United States
(12) Patent Application Publication
(10) Pub. No.: US 2002/0065889 A1
(43) Pub. Date: May 30, 2002

(54) PORTABLE ELECTRONIC MAIL MESSAGING DEVICE

(76) Inventor: JAMES MACOR, JACKSON, NJ (US)

Correspondence Address: STUART H MAYER, 14 KENNETH ROAD, UPPER MONTCLAIR, NJ, 07043

(21) Appl. No.: 09/061,682

(22) Filed: Apr. 16, 1998

(51) Int. Cl. G06F 15/16; H04M 11/10

(52) U.S. Cl. 709/206; 455/413

(57) ABSTRACT

In accordance with the present invention, a method and apparatus is provided for providing electronic mail to a subscriber. The subscriber's terminal, which may be a personal computer, for example, receives an incoming e-mail or voice mail message over a computer network in communication with the terminal. The terminal, in turn, transmits a radio signal from the terminal to a portable device. The radio signal includes the mail message.

The portable device receiving the electronic mail includes a wireless receiver for receiving the radio signal from the terminal, a processor and memory for processing and storing the radio signal, and a display for displaying the electronic mail.

In an alternative embodiment of the invention, a service provider such as a cellular telephone provider, for example, first receives the electronic mail. The electronic mail is intended for a subscriber of the service provider. The service provider in turn transmit the electronic mail to the subscriber's terminal and a portable device in the possession of the subscriber.

### TECHNICAL FIELD OF THE INVENTION

The present invention relates generally to portable messaging devices, and more particularly to a portable messaging device capable of receiving voice mail and electronic mail.

### BACKGROUND OF THE INVENTION

As the prevalence of electronic mail (“e-mail”) and voice mail systems increases, subscribers feel a growing need to retrieve such mail virtually as soon as it arrives. However, to promptly receive an incoming e-mail or voice mail message requires that a subscriber who is away from his or her home or office carry a device such as a portable computer. In many cases this is not a practical approach because of the size and expense of such devices.

A portable computer in effect, however, simply duplicates the functionality of the primary home or office computer. Such redundancy could be avoided if the primary computer or terminal were capable of relaying incoming messages at radio frequencies, for example, so that the subscriber could receive the messages on a simple receiver. In this way the subscriber can receive e-mail or voice messages without the need to have direct physical access to a computer terminal.

Accordingly, it would be desirable to provide a terminal such as a personal computer, which can easily relay messages to a subscriber in possession of a small, inexpensive device that can receive such electronic messages.

### BRIEF DESCRIPTION OF THE DRAWING

FIG. 1 shows one embodiment of the portable device constructed in accordance with the present invention receiving electronic messages from a terminal.

FIG. 2 shows a simplified block diagram of the terminal shown in FIG. 1.

FIG. 3 shows a simplified block diagram of the portable device shown in FIG. 1.

FIG. 4 is a flowchart showing the steps performed by the terminal shown in FIG. 1

FIG. 5 shows an alternative embodiment of the invention in which electronic messages are received by a service provider and forwarded to the portable device.

FIG. 6 is a flowchart showing the steps performed by the service provider shown in FIG. 4.

### DETAILED DESCRIPTION

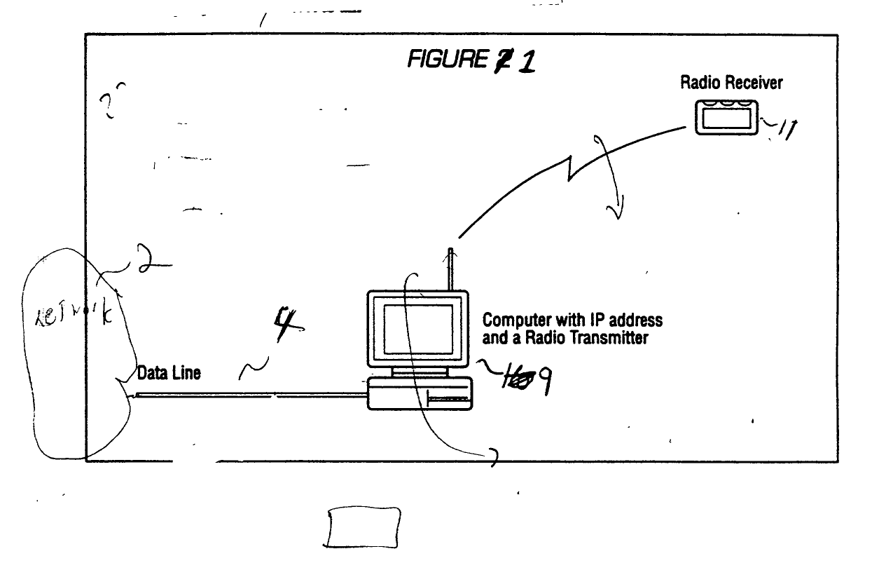

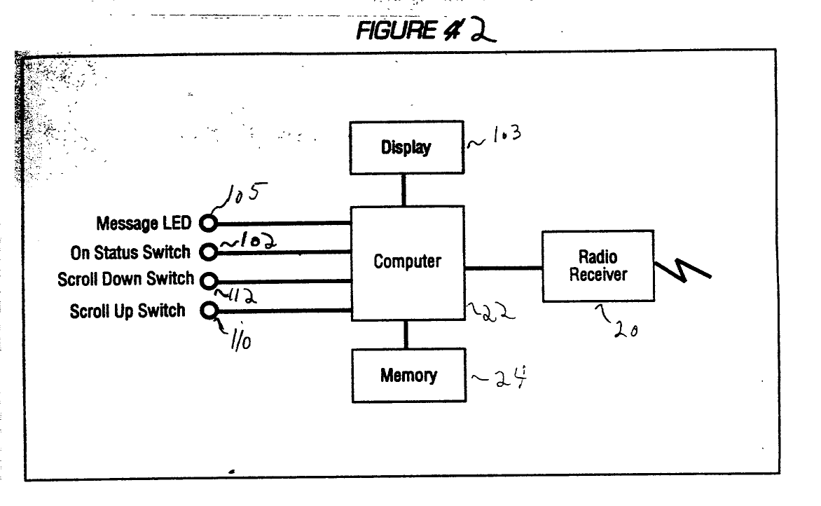

In accordance with the present invention as shown in FIG. 1, a terminal 9 for receiving electronic-mail is equipped with a wireless transmitter for transmitting the received e-mail to a portable device 11 that may be conveniently carried on the subscriber's person in a pocket or wallet, for example. In one embodiment of the invention, the terminal 9 is a personal computer connected over a data line 4 to a network 2 such as a local area network, for example. As shown in more detail in FIG. 2, the terminal 9 contains a processor 66, a local storage device 62, and a display 58. A radio frequency circuit board and transmitter 64, along with an antenna 56, are integrated into

### TECHNICAL FIELD OF THE INVENTION

The present invention relates generally to portable messaging devices, and more particularly to a portable messaging device capable of receiving voice mail and electronic mail.

### BACKGROUND OF THE INVENTION

As the prevalence of electronic mail (“e-mail”) and voice mail systems increases, subscribers feel a growing need to retrieve such mail virtually as soon as it arrives. However, to promptly receive an incoming e-mail or voice mail message requires that a subscriber who is away from his or her home or office carry a device such as a portable computer. In many cases this is not a practical approach because of the size and expense of such devices.

A portable computer in effect, however, simply duplicates the functionality of the primary home or office computer. Such redundancy could be avoided if the primary computer or terminal were capable of relaying incoming messages at radio frequencies, for example, so that the subscriber could receive the messages on a simple receiver. In this way the subscriber can receive e-mail or voice messages without the need to have direct physical access to a computer terminal.

Accordingly, it would be desirable to provide a terminal such as a personal computer, which can easily relay messages to a subscriber in possession of a small, inexpensive device that can receive such electronic messages.

### SUMMARY OF THE INVENTION

In accordance with the present invention, a method and apparatus is provided for providing electronic mail to a subscriber. The subscriber's terminal, which may be a personal computer, for example, receives an incoming e-mail or voice mail message over a computer network in communication with the terminal. The terminal, in turn, transmits a radio signal from the terminal to a portable device. The radio signal includes the mail message.

The portable device receiving the electronic mail includes a wireless receiver for receiving the radio signal from the terminal, a processor and memory for processing and storing the radio signal, and a display for displaying the electronic mail.

In an alternative embodiment of the invention, a service provider such as a cellular telephone provider, for example, first receives the electronic mail. The electronic mail is intended for a subscriber of the service provider. The service provider in turn transmits the electronic mail to the subscriber's terminal and a portable device in the possession of the subscriber.

### BRIEF DESCRIPTION OF THE DRAWING

FIG. 1 shows one embodiment of the portable device constructed in accordance with the present invention receiving electronic messages from a terminal.

FIG. 2 shows a simplified block diagram of the terminal shown in FIG. 1.

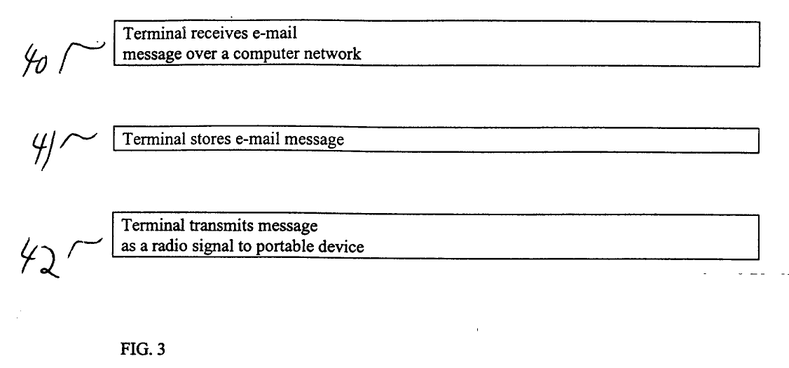

FIG. 3 shows a simplified block diagram of the portable device shown in FIG. 1.

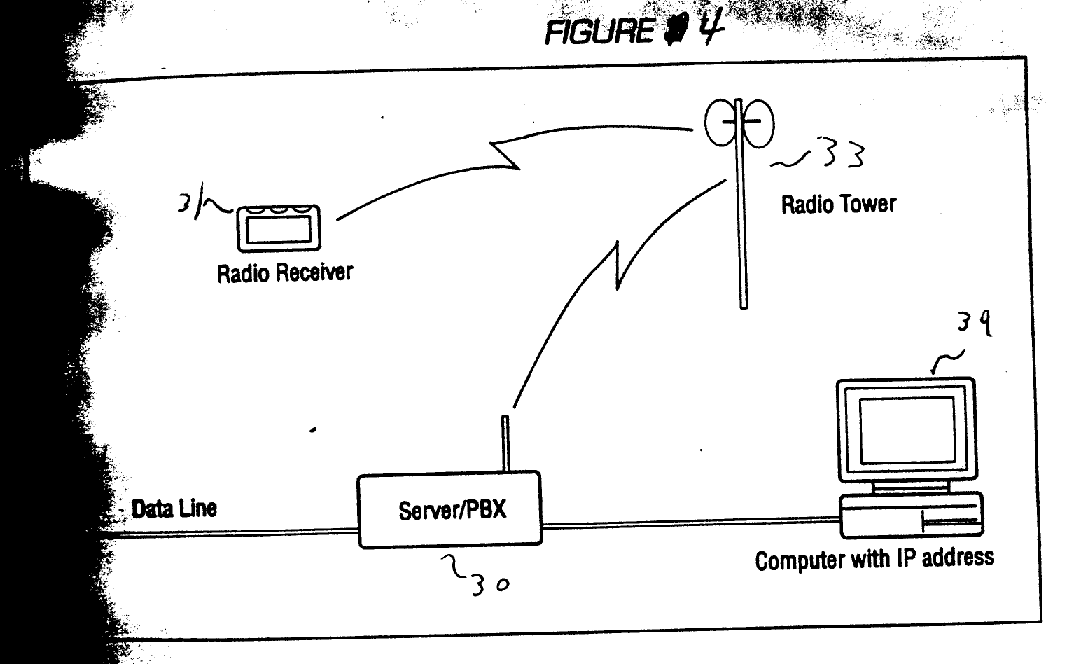

FIG. 4 is a flowchart showing the steps performed by the terminal shown in FIG. 1

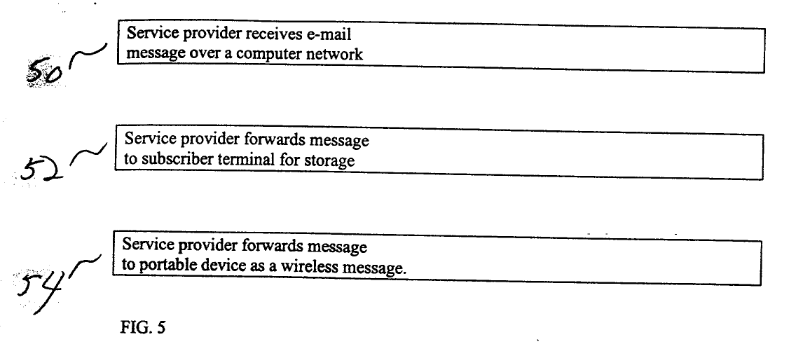

FIG. 5 shows an alternative embodiment of the invention in which electronic messages are received by a service provider and forwarded to the portable device.

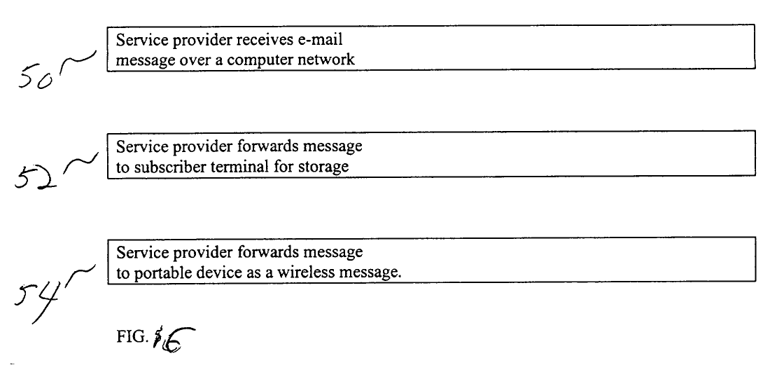

FIG. 6 is a flowchart showing the steps performed by the service provider shown in FIG. 4.

### DETAILED DESCRIPTION

In accordance with the present invention as shown in FIG. 1, a terminal 9 for receiving electronic-mail is equipped with a wireless transmitter for transmitting the received e-mail to a portable device 11 that may be conveniently carried on the subscriber's person in a pocket or wallet, for example. In one embodiment of the invention, the terminal 9 is a personal computer connected over a data line 4 to a network 2 such as a local area network, for example. As shown in more detail in FIG. 2, the terminal 9 contains a processor 66, a local storage device 62, and a display 58. A radio frequency circuit board and transmitter 64, along with an antenna 56, are integrated into the terminal 9. The transmitter 64 operates in accordance with known wireless technology such as employed in a cordless telephone base station. For example, the transmitter 64 can generate frequency modulated (FM) channels assigned to the portable device 11, such as in the 800-900 MHz range. Of course, the transmitter 64 could operate with RF signals of other wavelengths as well.

Mail messaging protocols are resident in the terminal 9 as software. The software 60 is a commercially available mail messaging package such as QuickMAIL PRO®, which is available from CE Software. Incoming electronic messages received through the software 60 are initially stored in the local storage device 62 and subsequently directed to the transmitter 64, which transmits the electronic messages to the portable device 11 as a radio signal. The entire process is actuated by a simple software protocol that operates in accordance with the software interface instructions specific to the terminal 9. The software employs a graphical user interface icon with which the user selects from among various options. Such options include the ability to activate and deactivate the transfer of messages to the portable device 11, as well as the ability to save and delete messages from the local storage device 62.

FIG. 3 shows a simplified block diagram of the portable device constructed in accordance with the present invention for receiving a subscriber's e-mail. As shown in FIG. 3, embedded within a portable housing is a wireless receiver 20, a processor 22, memory 24 and an electronic display 103 that extends over the housing surface. The receiver 20 receives the messages and stores them in memory 24. The messages are stored chronologically and displayed on display 103 in the order they are received. In the default mode the oldest unopened message in the memory 24 is displayed first. Once all the unopened mail has been displayed, any previously opened messages remaining in the memory 24 will be displayed. Depressing push-button 102 activates the display 103. A message indicator 105 such as an LED and/or a transducer, for example, alerts the subscriber that a message has arrived by emitting light or generating an audible tone, respectively. If desired, the indicator 105 can be deactivated, or possible altered between audio and visual indicating states, by any convenient means, such as by providing a small hole containing a recessed switch that is accessed by an object such as a pen. Scroll forward and scroll backward buttons 110 and 112 may be employed, for chronologically scrolling through a series of messages that have been received. Upon activation, the device operates in a default mode in which the most current message is displayed. The receiver 20 contained within the portable device is compatible with the transmitter located in the terminal 9. If cordless telephone technology is employed, the receiver 20 is of the type found in a conventional cordless telephone handset, which presently offers a range of up to almost a mile.

FIG. 4 shows a flowchart of the steps performed by the terminal 9. In step 40, the terminal 9 receives the e-mail message over the computer network 2 shown in FIG. 1. In step 41, the terminal 9 stores the e-mail message in its local storage device 62. Finally, in step 42, the terminal 9 transmits the message as a wireless signal to the portable device 11. The terminal 9 will re-transmit the wireless signal at periodic intervals until it receives confirmation from the portable device 11 that the message has been received.

The present invention contemplates numerous alternative embodiments to those depicted in FIGS. 2 and 3. For example, the previously-mentioned messaging protocols may be embodied in the terminal 9 as hardware, software, or a combination of both. Moreover, the transmitting method may operate in a variety of different ways. For example, instead of storing the message prior to it being transmitted to the portable device, the message may be transmitted to the portable device prior to, or even in lieu of, being stored in the terminal. Furthermore, the terminal 9 is not limited to personal computers. For example, the terminal 9 alternatively may be a terminal of limited processing capability having access to the Internet or other on-line system.

In an alternative embodiment of the invention shown in FIG. 5, the e-mail message need not be transmitted to the portable device by the subscriber terminal. Rather, the message may be initially directed to server 30 of a service provider over a data line connected to a computer network 2. The service provider's server 30 in turn transmits the message to both the subscriber terminal 39 (via a computer network) and the portable device 31 (via a wireless transmission). Thus, the subscriber is not required to be in constant communication with the subscriber terminal 39. The service provider advantageously may be an established cellular telephone or paging provider, in which case it would be particularly convenient to employ conventional cellular or paging technologies as the wireless technologies. In this alternative embodiment of the invention, the subscriber is not even required to be in communication with the subscriber terminal 39 at all since the service provider performs the function otherwise performed by terminal 39. Of course, at the subscriber's option, the e-mail also may be received at the electronic address of his or her terminal 39.

FIG. 6 shows a flowchart depicting the steps performed by the service provider server 30. In step 50, the service provider 30 receives the e-mail message over a computer network. In step 52, the service provider 30 forwards the message to the subscriber terminal 39 for electronic storage therein. In step 54, the service provider 30 also forwards the message to the portable device 31. Of course, the order in which steps 52 and 54 are performed may be reversed, or they may occur simultaneously.

The invention claimed is:

1. A method for providing electronic mail to a subscriber, said method comprising the steps of:
receiving at a subscriber terminal an electronic mail message over a computer network in communication with said terminal;
transmitting a radio signal from the terminal to a portable device, said radio signal including said electronic mail message.

2. The method of claim 1 wherein said computer network is a local area network.

3. The method of claim 1 wherein said computer network comprises the Internet.

4. The method of claim 1 wherein said terminal is a personal computer.

5. The method of claim 1 further comprising the step of storing said electronic mail message in the terminal.

6. The method of claim 5 wherein the storing step is performed prior to the step of transmitting.

7. An apparatus for providing electronic mail to a subscriber, comprising:
a subscriber terminal in communication with a computer network;
means for receiving at the terminal an electronic mail message over the computer network in communication with said terminal;
means for transmitting a radio signal from the terminal to a portable device, said radio signal including said electronic mail message.

8. The apparatus of claim 7 wherein said computer network is a local area network.

9. The apparatus of claim 7 wherein said computer network comprises the Internet.

10. The apparatus of claim 7 wherein said terminal is a personal computer.

11. The apparatus of claim 7 further comprising means for storing said electronic mail message in the terminal.

12. The apparatus of claim 11 wherein the storing means stores said electronic mail message prior to said transmitting means transmitting said radio signal.

13. The apparatus of claim 7 wherein said portable device includes:
second means for receiving the radio signal from the terminal;
a processor and memory for processing and storing said radio signal; and
a display for displaying said electronic mail message.

14. The apparatus of claim 13 further comprising an indicator coupled to said processor for activation upon receipt of the notification of an arrived message.

15. The apparatus of claim 14 wherein said indicator is an audible alarm.

16. The apparatus of claim 14 wherein said indicator is a light emitting diode

17. The apparatus of claim 13 further comprising a manually operable switch for activating and deactivating the display.

18. The apparatus of claim 17 wherein said switch is a push-button.

19. The apparatus of claim 17 further comprising a scroll button for chronologically scrolling through a series of electronic mail messages.

20. The apparatus of claim 19 wherein said scroll button comprises scroll forward and scroll backward buttons.

21. The apparatus of claim 13 wherein said second receiving means operates in conformance with cordless telephone technology.

22. A method for providing electronic mail to a subscriber of a service provider, said method comprising the steps of:
receiving at a service provider server an electronic mail message over a computer network in communication with said terminal;
transmitting a radio signal from the server to a subscriber terminal and to a portable device, said radio signal including said electronic mail message.

23. The method of claim 22 wherein said computer network is a local area network.

24. The method of claim 22 wherein said computer network comprises the Internet.

25. The method of claim 22 wherein said terminal is a personal computer.

26. The method of claim 22 further comprising the step of storing said electronic mail message in the server.

27. The method of claim 26 wherein the storing step is performed prior to the step of transmitting.
